(19) United States
(12) Patent Application Publication
(10) Pub. No.: US 2015/0010376 A1
(43) Pub. Date: Jan. 8, 2015

(54) BOLT-LIKE FASTENING ELEMENT, IN PARTICULAR DRILLING SCREW, AND CONNECTION ESTABLISHED THEREBY

(71) Applicant: SFS INTEC HOLDING AG, Heerbrugg (CH)

(72) Inventor: Marijo Zach, Widnau (CH)

(73) Assignee: SFS INTEC HOLDING AG, Heerbrugg (CH)

(21) Appl. No.: 14/379,405

(22) PCT Filed: Mar. 4, 2013
(86) PCT No.: PCT/EP2013/054265

§ 371 Date: Aug. 18, 2014

(30) Foreign Application Priority Data
Mar. 9, 2012 (DE) 102012102019.1

(51) Int. Cl. F16B 35/00

(52) U.S. Cl. CPC F16B 35/00
USPC 411/500

(57) ABSTRACT

A bolt-like fastening element (30), which is preferably in the form of a drilling screw shaped by pressing and/or rolling, having a head portion (LK), which has a holding region (LH) and has a starting hardness, and also having an initial portion (LA), which adjoins the head portion (LK) by way of a transition region (LÜ) and is additionally inductively hardened. The fastening element (30) is produced by cold forming from a blank made of a carbon steel having a starting tensile strength of at least 800 N/mm2. The induction hardening of the fastening element extends only to the initial portion thereof, i.e. in the case of a drilling screw to the drill bit (24) and the first turns of the thread (36). After the induction hardening, the drilling screw substantially has the starting tensile strength and is ductile in the head portion (LK). In the initial portion (LA) as far as into the central axis (33), the drilling screw is fully hardened to a hardness which is at least twice the magnitude of the starting hardness in the head portion (LK). The notched-impact energy in the head portion (LK) of the bolt-like fastening element is at least three times that in the initial portion (LA).

### BACKGROUND

The invention relates to a bolt-like fastening element, in particular a drilling screw, which is shaped by pressing and/or rolling, having a head portion, which has a holding region and has a starting hardness, and having an initial portion, which adjoins the head portion by way of a transition region and is additionally inductively hardened, such that the initial portion has a hardness which is higher than the starting hardness, wherein the fastening element is produced from carbon steel.

Drilling screws made of a carbon steel are presently fully carbonitrided. In the carbonitriding, the marginal layer of a workpiece, usually made of steel, is enriched with carbon and nitrogen by thermochemical treatment. The carbonitriding is generally carried out in a gas or in a salt bath. A carbonitrided screw is hard throughout, that is to say also has little ductility in the head portion. Carbonitriding is an expensive process. Moreover, the hardening is effected irrespective of length, i.e. the screw is hardened over its entire length. Screws of this type have a relatively low flexural strength and poor expansion properties in the shank region, which comprises the head portion, the holding portion and the initial portion. Examples of screws of this type are prior art, as will be shown hereinbelow.

The document DE 103 15 957 A1 discloses a screw of the type mentioned in the introduction with a partially hardened functional tip. The screw consists of a low-alloyed carbon steel. In the outer region of limited radial depth, the functional tip has a hardness which is greater than that in the holding portion. The screw body has been shaped by pressing and rolling and then the functional tip has been subjected to a hardening operation. Before the partial hardening of the functional tip, the screw body can be heat treated or case hardened as a whole. The heat treatment is effected by heating and subsequent quenching and tempering and the case hardening is effected by carburization or carbonitriding during the heating, this in turn being followed by quenching and tempering. This hardening impairs the ductility in the head portion of the screw. At the functional tip, the hardness does not extend over the entire circumference thereof, but rather only over partial regions of the circumference. The heating is effected by inductive heating. The drilling performance of a screw of this type is limited because the hardening is restricted to partial regions of the circumference of the functional tip.

In the case of screws made of stainless steel, it is common to weld a tip made of a carbon steel onto a shank made of stainless steel and to then inductively harden the tip. A screw of this type is known for example from the document DE 44 17 921 A1. The screw is produced from two blanks Part of the screw, specifically the head and the shank segment connected thereto, in this case consist of a tough, corrosion-resistant steel. The rest of the shank segment is manufactured from a hardened steel, and therefore it is possible to drill through lightweight metal, plastic and also high-grade steel sheet walls when this segment is designed as a drilling tip. The production of a screw of this type from two parts is complex. At the point at which the two blanks are welded to one another, the screw has a weld seam and a mixed microstructure.

The document DE 20 2009 011 665 U1 discloses a high-grade steel drilling screw of single part design. The screw, which consists entirely of stainless steel, is partially hardened at the drilling tip and in the adjoining thread-forming region. The remaining part of the screw, which is to remain unhardened, is covered beforehand with hardness protectants. The drilling tip and the thread-forming zone are case hardened. As an alternative, the marginal zone is carbonitrided, but this impairs the ductility.

The document DE 22 11 608 B2 discloses a thread-forming screw in which the hardening is localized in two respects, specifically both in the axial direction to the thread-forming portion and moreover in the radial direction to only part of the depth of this portion. The hardening is effected by induction hardening. The greatest hardness of the thread is limited to the thread-forming portion and extends here at most slightly into the thread core.

The document DE 15 08 416 C3 discloses a steel part, such as a bolt, made of a carbon steel which has a tensile strength of 70 to 120 kp/mm² (=687 to 1177 N/mm²) and which is uniformly fully hardened. In this case, the carbon steel comprising 0.2 to 0.6% carbon is a heat-treated steel and the steel part is a bolt or a screw.

### SUMMARY

It is an object of the invention to design a bolt-like fastening element, in particular a drilling screw, of the type mentioned in the introduction in such a way that a better ductility of the fastening element is achieved and brittle failure of the positioned fastening element is prevented.

Proceeding from a bolt-like fastening element of the type mentioned in the introduction, this object is achieved according to the invention in that the fastening element is produced by cold forming from a blank made of a carbon steel having a starting tensile strength of at least 800 N/mm², substantially has the starting tensile strength and is ductile in the head portion, and in the initial portion, as far as into the central axis, is fully hardened to a hardness which is at least twice as high as the starting hardness in the head portion, and in that the notched-impact energy in the head portion (LK) of the bolt-like fastening element is at least three times that in the initial portion (LA).

The fastening element according to the invention affords the following advantages over the outlined prior art:
it is suitable for special requirements and new applications
the hardening is effected irrespective of length and inductively only in the initial portion
the production is economical because the fastening element is hardened only at the tip, i.e. only partially
the fastening element according to the invention in the form of a drilling screw is a pure carbon steel screw with partial inductive hardening of the drilling tip and thread and with a soft shank
the drilling tip is fully hardened
the hardness length is definable
greater expansion in the shank
better drilling performances since full hardening is effected at the tip
compared to a design made of stainless steel: no mixed microstructure and no weld seam
the hardened drilling tip gives rise to a higher drilling and forming performance
the soft shank (head portion) yields increased bending and expansion properties
the hardening process can follow the rolling process directly and can be carried out in the same installation as the rolling process

Advantageous configurations of the bolt-like fastening element according to the invention form the subject of the dependent claims.

In one configuration of the bolt-like fastening element according to the invention, the carbon steel is a heat-treated steel. Heat-treated steel is an unalloyed or alloyed structural steel which, on account of its chemical composition, is suitable for heat treatment. The achievable hardness depends substantially on the C content. The steel assumes a high strength and hardness through the hardening—quenching from the heat treatment temperature, which, depending on the grade, can be above 800 to approximately 900° C. In the present configuration of the invention, use is made of a heat-treated steel which is suitable for induction hardening, e.g. the heat-treated steel C60E. This is an unalloyed steel, with which it is possible to achieve tensile strengths of 750 to 900 N/mm². Heat-treated steels are used with preference for the manufacture of screws. Further information relating to heat-treated steels can be found in “Vergütungsstähle, Verwendung der Stähle/Stähle mit besonderen Eigenschaften”, A Series of Technical Papers, Brntsch-Rüegger AG, Internet: www.brr.ch, this involving an excerpt from Stahlreport 12/99.

In a further configuration of the bolt-like fastening element according to the invention, the latter is a drilling screw with a drilling tip, a rivet, a bolt, a nail or a spike. The advantages of the invention are achieved irrespective of the nature of the bolt-like fastening element.

In a further configuration of the bolt-like fastening element according to the invention, the central axis in the head portion can be bent through at least 90° with respect to the central axis in the initial portion, the bend being made in a thread-free part of the head portion if the bolt-like fastening element is a drilling screw. In this respect, a nail bending apparatus in accordance with EN 409:1993 can be used for the verification of a bendability free of brittle fracture.

In a further configuration of the bolt-like fastening element according to the invention, the central axis in the holding region of the head portion can be bent through at least 45° with respect to the central axis in the initial portion if the bend is made in the holding region provided with a thread. In this case, too, the aforementioned nail bending apparatus can be used for the verification of a bendability free of brittle fracture.

In a further configuration of the bolt-like fastening element according to the invention, the starting hardness in the head portion is 250 HV_{0.3}. In the case of the bolt-like fastening element according to the invention, the hardness is at least twice the magnitude after the latter has been induction hardened, i.e. it has a value of at least 500 HV_{0.3}.

Finally, the invention provides a connection of parts of a shell to a building using a bolt-like fastening element according to the invention and also a connection of parts to the roof of a building using a bolt-like fastening element according to the invention.

### BRIEF DESCRIPTION OF THE DRAWINGS

Exemplary embodiments of the invention will be described in more detail hereinbelow with reference to the drawings, in which:

FIG. 1 shows a graph of the hardness profile, in which the Vickers hardness is plotted against the hardening length,

FIG. 2 shows a first embodiment of a bolt-like fastening element according to the invention, which is in the form of a spike and in the case of which the hardness profile shown in FIG. 1 arises,

FIG. 3 shows the spike shown in FIG. 2, but bent through 90° in the head portion,

FIG. 4 shows a graph for the hardness profile for a second embodiment of the bolt-like fastening element according to the invention, in which the Vickers hardness is plotted against the hardening length,

FIG. 5 shows the second embodiment of the bolt-like fastening element according to the invention, which is in the form of a screw with a penetration tip and in the case of which the hardness profile shown in FIG. 4 arises,

FIG. 6 shows the screw shown in FIG. 5, but bent through 90° in the head portion,

FIG. 7 shows the screw shown in FIG. 5, but bent through 45° in a holding region of the head portion,

FIG. 8 shows a graph for the hardness profile for a third embodiment of the bolt-like fastening element according to the invention, in which the Vickers hardness is plotted against the hardening length,

FIG. 9 shows the third embodiment of the bolt-like fastening element, which is in the form of a drilling screw with a drilling tip and in the case of which the hardness profile shown in FIG. 8 arises,

FIG. 10 shows the drilling screw with a drilling tip shown in FIG. 9, but bent through 90° in the head portion, and

FIG. 11 shows the drilling screw with a drilling tip shown in FIG. 9, but bent through 45° in a holding region of the head portion.

### DETAILED DESCRIPTION OF THE PREFERRED EMBODIMENTS

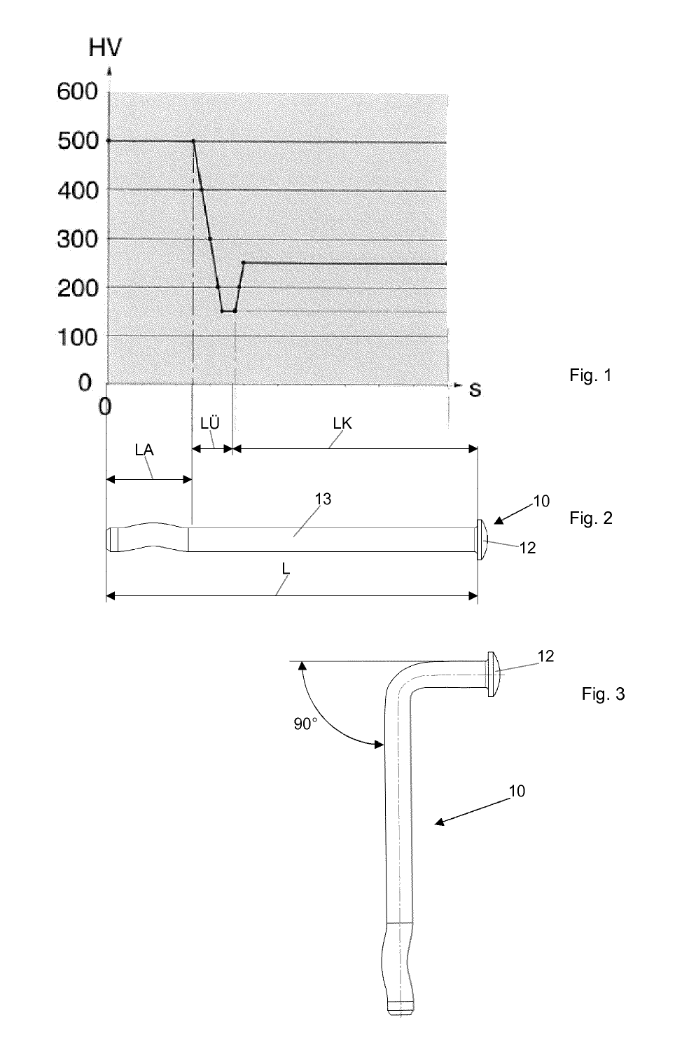

FIGS. 1-3 relate to a first embodiment of a bolt-like fastening element according to the invention, which is in the form of a spike denoted as a whole by 10. As shown in the illustration in FIG. 2, the spike 10 has a length L and over this length a head portion LK and an initial portion LA, which adjoins the head portion LK by way of a transition region LÜ. In the initial portion LA, the spike 10 is provided with a bend, by virtue of which the clear width of the spike 10, which would otherwise be the same as the shank diameter of the spike 10, is accordingly enlarged. A spike makes it possible to establish fastenings in concrete without it being necessary to use a dowel. A borehole corresponding substantially to the shank diameter of the spike is made in the concrete. The spike is driven into this borehole. In this process, the shank is stretched somewhat in the initial portion LA. As a result of the stress which thereby arises between the initial portion LA and the borehole wall, the spike is anchored in a force-fitting manner in the borehole.

The spike 10 has a starting hardness, this being increased by partial inductive hardening of the spike 10 in the initial portion LA to a value which is at least twice as high as the starting hardness in the head portion LK. If the spike 10 is formed of a carbon steel, it has a starting tensile strength of at least 800 N/mm². It is brought into the shape shown in FIG. 2 by cold forming. At the end opposite to the initial portion LA, the spike 10 has a head 12.

FIG. 1 shows, plotted over the length L of the spike 10, a graph of the hardness profile, in which the Vickers hardness is plotted against the hardening length s. The graph shows that the starting hardness in the head portion LK is 250 HV and, after the induction hardening, in the initial portion is 500 HV. The hardness initially drops to a relatively low value of approximately 150 HV in the transition region LÜ, remains at this value over a short piece of the hardness length and then rises linearly to twice the starting hardness, that is to say to 500 HV. It has been found to be advantageous if the increase in the hardness over the starting hardness is at least 2:1. The reduction in the hardness in the transition region LÜ should be at most 50%.

The carbon steel used for the spike 10 is preferably a heat-treated steel, preferably the low-alloyed C steel C60E.

The spike 10 is produced by cold forming from a blank made of a carbon steel wire having the aforementioned starting tensile strength of at least 800 N/mm². The shank region of the fastening element 10, which corresponds to the head portion LK, retains the starting tensile strength and remains ductile, because the induction hardening of the spike 10 is limited to the initial portion LA and the transition region LÜ. In the initial portion LA, as far as into a central axis 12, the spike 10 is fully hardened to a hardness which, as mentioned, is at least twice as high as the starting hardness in the head portion LK.

The ductility of the spike 10 is expressed in the fact that the notched-impact energy in the head portion LK is at least three times that in the initial portion LA.

Furthermore, the ductility, which the spike 10 also has after the induction hardening, can be seen in the fact that the central axis 13 in the head portion LK can be bent through at least 90° with respect to the central axis 13 in the initial portion LA, the bend being made in a thread-free region of the head portion if, as in the third embodiment of the invention, the bolt-like fastening element is a tapping or drilling screw 20 or 30, further details of which will be provided further below with reference to FIGS. 5-11.

The question as to whether a bolt-like fastening element can be bent through 90°, as is shown for the spike 10 in FIG. 3, without the shank thereof breaking or chipping at the bending point or suffering other damage, e.g. brittle fracture at the bending point, can be tested by a nail bending apparatus in accordance with EN 409:1993. In the case of the spike 10, this bending test showed that it is possible to bend the shank in the head portion LK without visible damage, in particular without brittle failure which is otherwise common. The bending test can be used to measure and show that there is improved ductility and no longer brittle fracture in the case of the bolt-like fastening element according to the invention as compared to the prior art outlined in the introduction.

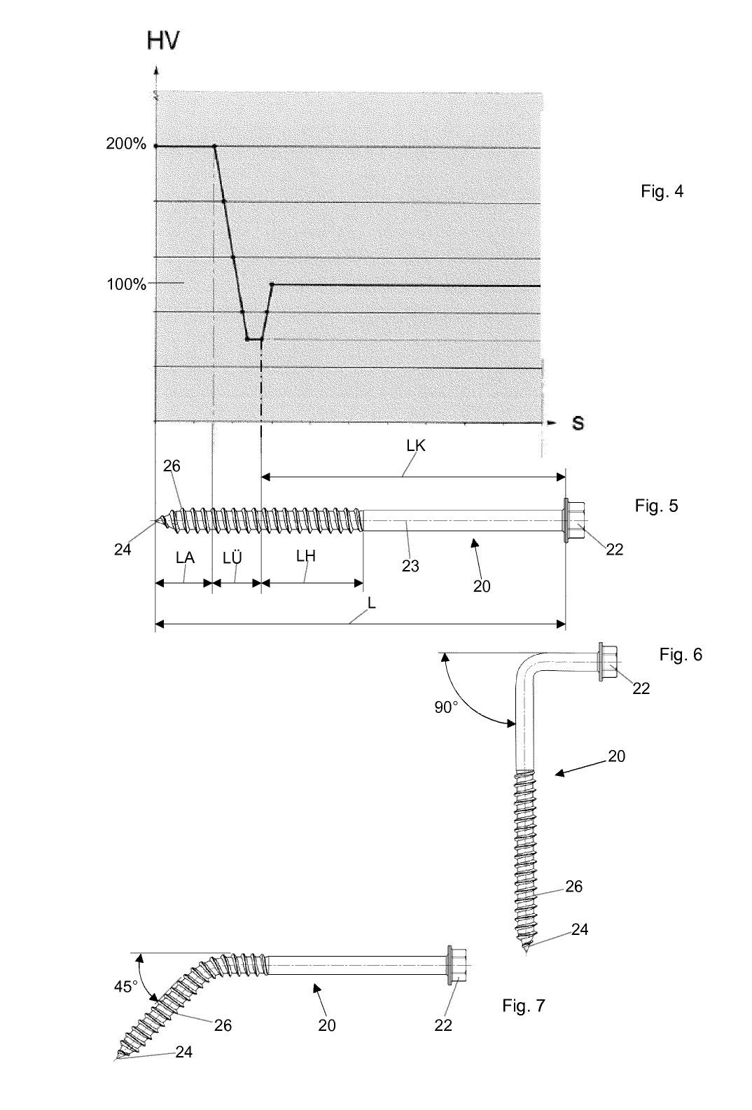

FIGS. 4-7 show a second embodiment of the invention, in which the bolt-like fastening element is a tapping screw, denoted as a whole by 20, which has a head 22, a penetration tip 24 and a thread 26. As shown in the illustration in FIG. 5, the thread 26 extends over an initial portion LA, a transition region LÜ and a holding region LH. The holding region LH is part of a head portion LK. The shank of the tapping screw 20 has a length L, including the penetration tip 24.

The thread 26 is a tapping thread, e.g. as in a chipboard screw or sheet-metal screw. The tapping screw 20 provided with the penetration tip 24 self taps its thread.

FIG. 4 shows a graph for the hardness profile over the hardness length s, which corresponds to the length L of the tapping screw 20. Although the Vickers hardness HV is again plotted against the hardness length s, the starting hardness and the hardness after the induction hardening are each given in percent, specifically with 100% and 200% respectively. The hardness profile corresponds to that shown in FIG. 1 and therefore does not need to be described in more detail. As is the case in FIG. 1, the end hardness in the initial portion LA is twice the starting hardness in the head portion LK.

It is preferable to harden the penetration tip 24, the run in and at most eight thread turns or at most 10 mm of the thread 26.

FIG. 6 shows the tapping screw 20 shown in FIG. 5, but bent through 90° in the thread-free part of the head portion LK.

In the case of the tapping screw 20 shown in FIG. 6, the central axis 23 in the holding region LH of the head portion LG can be bent through 45° with respect to the central axis 23 in the initial portion LA, without there being any brittle failure of or other damage to the fastening element. This is shown in FIG. 7.

The test results achieved with the aforementioned nail bending apparatus in accordance with EN 409:1993 are of the same quality as for the spike 10 shown in FIGS. 1-3.

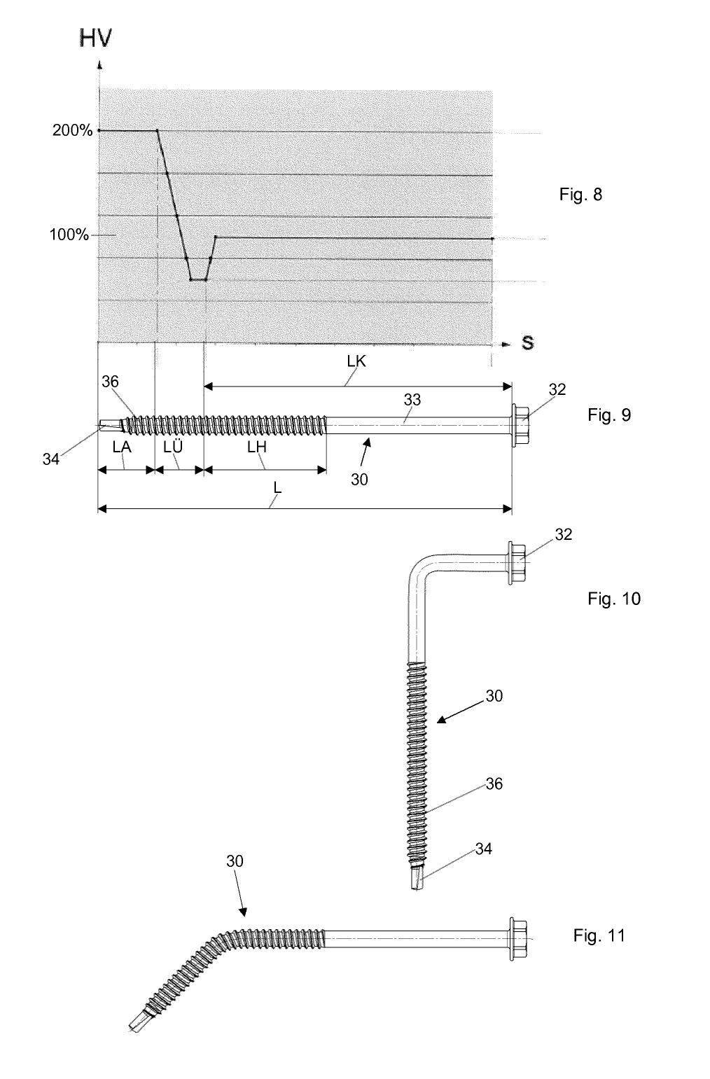

FIGS. 8-11 show a third embodiment of the fastening element according to the invention, which is in the form of a drilling screw and is denoted as a whole by 30. The drilling screw 30 has a head 32, a drilling tip 34 and a thread 36.

FIG. 8 in turn shows a graph for the hardness profile, in this case for the drilling screw 30, the Vickers hardness HV being plotted against the hardness length s in the graph. FIG. 9 shows the drilling screw 30, over the length L of which the hardness profile shown in FIG. 8 arises. In the illustration shown in FIG. 10, the drilling screw 30 as shown in FIG. 9 is bent through 90° in the head portion LK. In the illustration shown in FIG. 11, the drilling screw 30 as shown in FIG. 9 is bent through 45° in a holding region LH of the head portion LK.

For the rest, the same explanations as those made in relation to the second embodiment of the invention as shown in FIGS. 4-7 apply to the third embodiment of the invention as shown in FIGS. 8-11.

### LIST OF REFERENCE SIGNS

10 Fastening element (first embodiment, spike)
12 Head
13 Central axis
20 Fastening element (second embodiment, tapping screw)
22 Head
23 Central axis
24 Penetration tip
26 Thread
30 Fastening element (third embodiment, drilling screw)
32 Head
33 Central axis
34 Drilling tip
36 Thread
L Length of fastening element
LA Initial portion
LÜ Transition region
LH Holding region
LK Head portion
s Hardness length
HV Vickers hardness

1. A fastening element which is shaped by pressing or rolling, comprising:
a head portion (LK), which has a holding region (LH) and has a starting hardness,
an initial portion (LA), which adjoins the head portion (LK) by way of a transition region (LÜ),
wherein the fastening element is produced from carbon steel,
wherein the fastening element substantially has the starting tensile strength and is ductile in the head portion (LK),
the fastening element cold formed from a blank having a starting tensile strength of at least 800 N/mm²,
the initial portion is inductively hardened, such that the initial portion (LA) has a hardness which is higher than the starting hardness,
in the initial portion (LA), as far as into a central axis (13, 23, 33), the fastening element is fully hardened to a hardness which is at least twice as high as the starting hardness in the head portion (LK), and
a notched-impact energy in the head portion (LK) of the fastening element is at least three times that in the initial portion (LA).

2. The fastening element as claimed in claim 1, wherein the carbon steel is a heat-treated steel.

3. The fastening element as claimed in claim 1, wherein the fastening element is a drilling screw (30) with a drilling tip (34), a rivet, a bolt, a nail or a spike (10).

4. The fastening element as claimed in claim 3, wherein the central axis (13, 23, 33) in the head portion (LK) is bendable through at least 90° with respect to the central axis (13, 23, 33) in the initial portion (LA), the bend being made in a thread-free part of the head portion (LK) if the fastening element is the drilling screw (30).

5. The bolt-like fastening element as claimed in claim 3, wherein the central axis (13, 23, 33) in the holding region (LH) of the head portion (LK) is bendable through at least 45° with respect to the central axis (13, 23, 33) in the initial portion (LA) if the bend is made in the holding region (LH) provided with a thread (26, 36).

6. The fastening element as claimed in claim 1, wherein the starting hardness in the head portion (LK) is 250 HV_{0.3}.

7. A connection of parts of a shell to a building using the fastening element as claimed in claim 1.

8. A connection of parts to the roof of a building using the fastening element as claimed in claim 1.
